(19) United States
(12) Patent Application Publication
(10) Pub. No.: US 2016/0292154 A1
(43) Pub. Date: Oct. 6, 2016

(54) Methods and Apparatuses for Providing Document Workflow Management

(71) Applicant: McKesson Corporation, San Francisco, CA (US)

(72) Inventors: Brian Campbell, Cumming, GA (US); Nawneet Jha, Alpharetta, GA (US); Ken Gardner, Cumming, GA (US); Allison Kendrix, Cumming, GA (US)

(21) Appl. No.: 14/674,598

(22) Filed: Mar. 31, 2015

(51) Int. Cl. G06F 17/30; G06F 17/27

(52) U.S. Cl. CPC G06F 17/30011; G06F 17/2705; G06F 17/30312

(57) ABSTRACT

A method, apparatus and computer program product are provided for programmatic evaluation of document workflows. An example of the method includes receiving a document workflow object, the document workflow object comprising a string defining a set of rule criteria and an indicator of at least one task to be performed in response to meeting the set of rule criteria, storing the document workflow object in an object datastore, the object datastore stored in a memory, evaluating the document workflow object using a workflow engine executed on a processor, and, in response to evaluating the document workflow object, executing, by the workflow engine, the at least one task. Evaluating the document workflow object includes parsing the string to generate a set of machine-readable instructions for evaluating the rule criteria, executing the instructions to evaluate the rule criteria, and determining that the rule criteria are satisfied based at least in part on execution of the instructions determining that at least one document is present within a document repository.

### TECHNOLOGICAL FIELD

Example embodiments of the present invention relate generally to methods and systems for providing document workflows and, more particularly, to methods and apparatuses for providing document workflow management.

### BACKGROUND

As personal computers and enterprise document storage capabilities have become more and more common, more and more industries are converting paper-based document filing systems to electronic records systems. By leveraging the communication capabilities of modern computers, these electronic records systems are capable of functioning not only as storage repositories, but also workflow management systems. These workflow management systems assist users by managing access to particular sets of documents, and providing basic programmatic tasks in response to detection of certain documents.

However, known workflow management systems are often inadequate for certain industries, facilities, and/or use cases. For example, management of patient data in a healthcare setting often includes management of tens or hundreds of thousands of documents relating to patient encounters with practitioners, stored patient medical histories, lab results, imaging studies, insurance and billing records, and the like. Known document workflow systems are inflexible, requiring adherence to rigid schemas and rule frameworks that are tightly coupled to particular document types and hard-coded events. Through applied effort, ingenuity, and innovation, Applicant has solved many of these identified problems by developing a technical solution that is embodied by the present invention, which is described in detail below.

### BRIEF SUMMARY

Methods, apparatuses and computer program products are therefore provided according to example embodiments of the present invention in order to implement a system for document workflow management that allows for flexible definition, storage, and evaluation of document workflow objects. Such document workflow objects may be extended to detect the arrival of documents to a document workflow system for any number of domains, including but not limited to medical records systems, materials management systems, human resources, accounts payable, legal systems, and the like. As a specific example, embodiments of the present invention may be employed in the OneContent document management system provided by McKesson® Corporation. Embodiments include a method for managing a document workflow. The method includes receiving a document workflow object, the document workflow object comprising a string defining a set of rule criteria and an indicator of at least one task to be performed in response to meeting the set of rule criteria, storing the document workflow object in an object datastore, the object datastore stored in a memory, and evaluating the document workflow object using a workflow engine executed on a processor. Evaluating the document workflow object includes parsing the string to generate a set of machine-readable instructions for evaluating the rule criteria, executing the instructions to evaluate the rule criteria, and determining that the rule criteria are satisfied based at least in part on execution of the instructions determining that at least one document is present within a document repository. The method also includes, in response to evaluating the document workflow object, executing, by the workflow engine, the at least one task.

The document repository may be a medical records document store. The document workflow object may include a frequency interval, and the document workflow object may be evaluated by the workflow engine at a particular time based at least in part on the frequency interval. The string may define a JavaScript Object Notation (JSON) object. The document workflow object may be received from an interface configured to generate the document workflow object based on user input received by the interface. The machine-readable instructions may be determined from parsing the rule criteria comprise at least one query executed against the document repository. The rule criteria may define at least one document view and the document view may include a plurality of document types stored in the document repository. The document workflow object may include a first priority rating for evaluation of the document workflow object, and the document workflow object may be selected for evaluation based at least in part on the first priority rating being greater than at least one other priority rating associated with a different document workflow object. The method may include determining that the rule criteria have not been met based on execution of the machine-readable instructions and, in response to determining that the rule criteria have not been met, scheduling a subsequent evaluation of the document workflow object by the workflow engine. A time of the subsequent evaluation may be determined based at least in part on a frequency interval associated with the document workflow object.

Embodiments also include an apparatus for managing a document workflow. The apparatus includes workflow engine circuitry configured to, receive a document workflow object, the document workflow object comprising a string defining a set of rule criteria and an indicator of at least one task to be performed in response to meeting the set of rule criteria, store the document workflow object in an object datastore, the object datastore stored in a memory, and evaluate the document workflow object using a workflow engine executed on a processor. Evaluating the document workflow object comprises parsing the string to generate a set of machine-readable instructions for evaluating the rule criteria, executing the instructions to evaluate the rule criteria, and determining that the rule criteria are satisfied based at least in part on execution of the instructions determining that at least one document is present within a document repository. The workflow engine circuitry is also configured to, in response to evaluating the document workflow object, execute the at least one task.

The document repository may be a medical records document store. The document workflow object may include a frequency interval, and the document workflow object may be evaluated by the workflow engine at a particular time based at least in part on the frequency interval. The string may define a JavaScript Object Notation (JSON) object. The document workflow object may include a first priority rating for evaluation of the document workflow object, and the document workflow object may be selected for evaluation based at least in part on the first priority rating being greater than at least one other priority rating associated with a different document workflow object. The workflow engine circuitry may be further configured to determine that the rule criteria have not been met based on execution of the machine-readable instructions and, in response to determining that the rule criteria have not been met, schedule a subsequent evaluation of the document workflow object by the workflow engine. A time of the subsequent evaluation may be determined based at least in part on a frequency interval associated with the document workflow object.

Embodiments also include a non-transitory computer readable storage medium comprising instructions that, when executed by a processor, configure the processor. The instructions configure the processor to receive a document workflow object, the document workflow object comprising a string defining a set of rule criteria and an indicator of at least one task to be performed in response to meeting the set of rule criteria, store the document workflow object in an object datastore, the object datastore stored in a memory, and evaluate the document workflow object using a workflow engine executed on a processor. Evaluating the document workflow object comprises parsing the string to generate a set of machine-readable instructions for evaluating the rule criteria, executing the instructions to evaluate the rule criteria, and determining that the rule criteria are satisfied based at least in part on execution of the instructions determining that at least one document is present within a document repository. The instructions also configure the processor to, in response to evaluating the document workflow object, execute the at least one task. The document repository may be a medical records document store. The document workflow object may include a frequency interval, and the document workflow object may be evaluated by the workflow engine at a particular time based at least in part on the frequency interval.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specially configured to manage a document workflow in accordance with some embodiments of the present invention;

FIG. 2 is a block diagram of a dataflow between logical components of a document workflow management system in accordance with some embodiments of the present invention;

FIG. 3 is an illustration depicting an interface for defining elements of a document workflow object in accordance with some embodiments of the present invention;

FIG. 4 is an illustration depicting a flow diagram of a process for generating a document workflow object in accordance with some embodiments of the present invention; and

FIG. 5 is an illustration depicting a flow diagram of a process for performing document workflow management using a document workflow object generated by embodiments of the present invention in accordance with some embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### INTRODUCTION AND DEFINITIONS

A method, apparatus and computer program product are provided in accordance with example embodiments of the present invention to provide a document workflow framework that allows for flexible definition and generation of document workflow objects. Embodiments further provide for managing of a document workflow in accordance with the generated document workflow objects. As noted above, the inventors have identified that current systems for document workflow management are rigid and inflexible, requiring the use of hard-coded rules and strict document typing. In this regard, the inventors have developed novel systems and techniques that provide for generation, storage, and use of document workflow objects that are defined in a flexible, robust, easily-parsed format. In some embodiments, document workflow objects are generated through the use of an interface, and the interface generates strings that define the document workflow object (e.g., a string or set of strings that defines a JavaScript Object Notation (JSON) object), along with certain other parameters related to the workflow object, such as a priority and a frequency interval. A workflow engine may identify particular rules for processing based on a timestamp and the frequency interval, and at a time determined by the frequency interval and the timestamp, parse the document workflow object and, as a result of the parsing, evaluate criteria stored in the document workflow object. In the event the criteria are satisfied, the document workflow engine may execute processing associated with the document workflow object to perform a task or tasks.

To support this novel functionality, the inventors have developed various novel data structures, interfaces, functions, algorithms, databases, libraries, and the like that allow for generation and evaluation of document workflow objects. These assets may implement, for example, interfaces and/or applications for generating document workflow objects, transmission of created document workflow objects to a document workflow engine, processing and parsing of document workflow objects by the document workflow engine, evaluating criteria determined as a result of the processing and parsing, and performing actions based on the result of the evaluation of the criteria. In some embodiments, the document workflow engine may implement an Application Programming Interface (API) (e.g., a Representational State Transfer (REST) API), and/or various web services (e.g., REST web services) for management of document workflow objects used by the document workflow engine. For example, an interface application may access stored document workflow objects, generate new document workflow objects, delete document workflow objects, and the like through a series of REST web service calls.

For the purposes of this disclosure, the term “document workflow engine” refers to hardware or software configured to electronically access a document repository and evaluate whether particular criteria are satisfied by one or more documents within the document repository. In the event the criteria are satisfied, the document workflow engine executes certain tasks associated with those criteria.

For the purposes of this disclosure, the term “document workflow object” refers to a set of electronic data that, when evaluated by a document workflow engine, provides the document workflow engine with a set of criteria for evaluation and identifies a particular task to be performed based on the results of the evaluation of the criteria. Document workflow objects may also include metadata used for controlling the evaluation (e.g., a frequency and/or a priority), performing metrics (e.g., a type of the workflow object), identifying the workflow object (e.g., a text name or comment), or the like.

### Example Client Apparatus

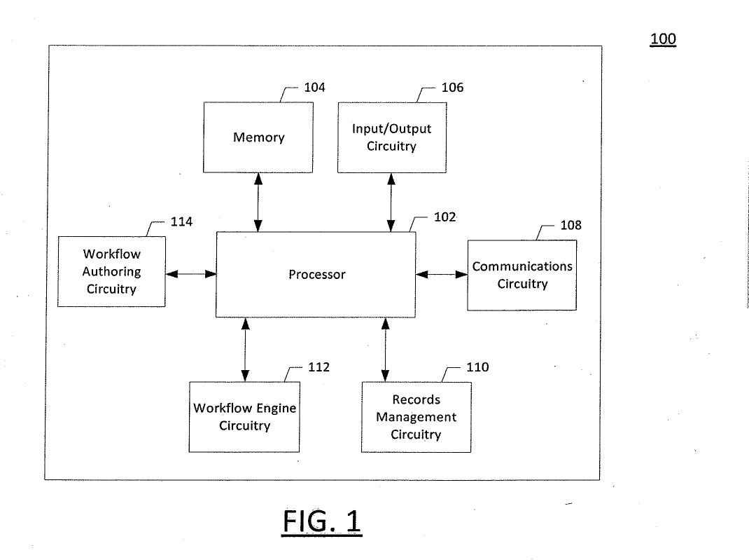

FIG. 1 illustrates a block diagram of an apparatus 100 in accordance with some example embodiments. The apparatus 100 may be any computing device for implementing a document workflow management system as described herein. For example, the apparatus 100 may be implemented as any device capable of generating one or more document workflow objects and/or using those document workflow objects to perform document workflow management against a document repository. In some embodiments, the apparatus 100 may execute an interface and/or application for defining, generating, accessing, or modifying document workflow objects, and the document workflow engine may process the generated document workflow objects on another computer node. In some embodiments, the apparatus 100 may execute the document workflow engine and the document workflow objects may be generated on another computing node. In yet further embodiments, the apparatus 100 may both provide an interface for generating, defining, accessing, and/or modifying document workflow objects and also execute the document workflow engine. In some embodiments the apparatus 100 also provides a document repository, while in other embodiments, the document repository may be located at a remote computing node from the apparatus 100. In this regard, the apparatus 100 may be implemented as a standalone or rack-mounted server, a desktop computer, a laptop computer, a personal digital assistant, a tablet computer, a netbook computer, a picture archiving and communication system (PACS) workstation, or the like. Accordingly, it will be appreciated that the apparatus 100 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

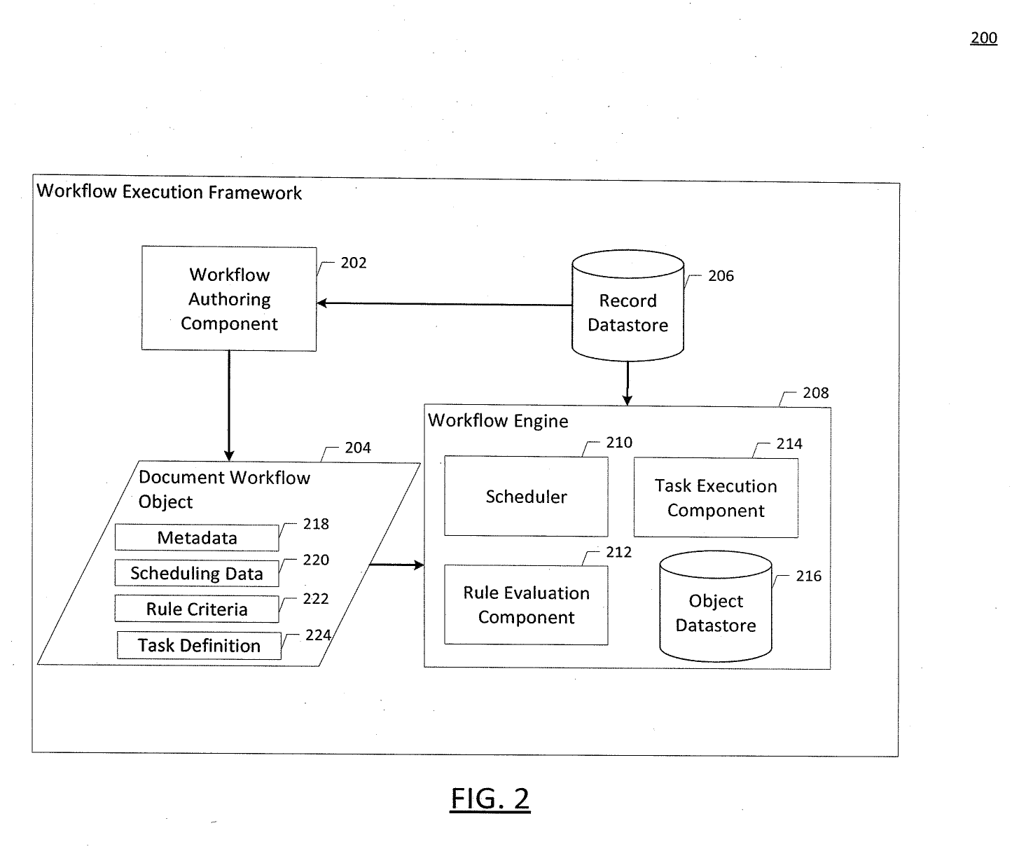

As illustrated in FIG. 1, an apparatus 100 may include a processor 102, a memory 104, input/output circuitry 106, communications circuitry 108, records management circuitry 110, workflow engine circuitry 112, and workflow authoring circuitry 114. The apparatus 100 may be configured to execute the operations described below with respect to FIGS. 2-5. Although these components 102-114 are described with respect to functional limitations, it should be understood that the particular implementations necessarily include the use of particular hardware. It should also be understood that certain of these components 102-114 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 100 may provide or supplement the functionality of particular circuitry. For example, the processor 102 may provide processing functionality, the memory 104 may provide storage functionality, the communications circuitry 108 may provide network interface functionality, and the like.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory may be an electronic storage device (e.g., a computer readable storage medium). The memory 104 may be configured to store information, data, content, applications, instructions, tables, data structures, or the like, for enabling the apparatus to carry out various functions in accordance with example embodiments of the present invention.

The processor 102 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In an example embodiment, the processor 102 may be configured to execute instructions stored in the memory 104 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 100 may include input/output circuitry 106 that may, in turn, be in communication with processor 102 to provide output to the user and, in some embodiments, to receive an indication of a user input. The input/output circuitry 106 may comprise a user interface and may include a display and may comprise a web user interface, a mobile application, a client device, a kiosk, or the like. In some embodiments, the input/output circuitry 106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

The communications circuitry 108 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 108 may include, for example, a network interface for enabling communications with a wired or wireless communication network. For example, the communications circuitry 108 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The records management circuitry 110 includes hardware configured to provide or communicate with one or more document repositories. The records management circuitry 110 may interact with the document repository to identify which documents are stored in the repository, to identify document metadata associated with documents stored in the document repository (e.g., document types, modification dates, document names, etc.), to retrieve documents from the document repository, to move documents to other locations within the document repository, to move documents from a first document repository to a second document repository, to store documents in the document repository, or the like. The records management circuitry 110 may also implement one or more “views” of documents in the repository to display a particular set of documents or otherwise filter or provide access to a subset of documents stored within the repository. The records management circuitry 110 may, for example, execute the document repository local to the apparatus, or the records management circuitry 110 may interact with one or more documents repositories executing on remote devices through the use of a network interface, shared bus, or the like. To perform these functions, the records management circuitry 110 may utilize the processor 102 and/or communications circuitry 108. It should also be appreciated that, in some embodiments, the credential management circuitry 110 may include a separate processor, specially configured field programmable gate array (FPGA), or application specific interface circuit (ASIC) for providing and/or accessing the document repository. The records management circuitry 110 is therefore implemented using hardware components of the apparatus configured by either hardware or software for implementing these planned functions.

The workflow engine circuitry 112 includes hardware configured to provide a document workflow engine as described above and herein. The workflow engine circuitry 112 may interact with the records management circuitry 110 to access documents stored within a document repository and evaluate those documents according to one or more document workflow objects. The workflow engine circuitry 112 may be further configured to parse data contained within the document workflow objects to identify particular criteria, tasks, evaluation periods, and the like for determining whether to perform certain tasks based on the presence of documents within the document repository. Embodiments may store document workflow objects in a memory, such as the memory 104. The workflow engine circuitry 112 may interact with the processor 102 for implementing the document workflow engine, though it should be appreciated that the workflow engine circuitry may include a separate processor, FPGA, ASIC, or the like. The workflow engine circuitry 112 is therefore implemented using hardware components of the apparatus configured by either hardware or software for implementing these planned functions.

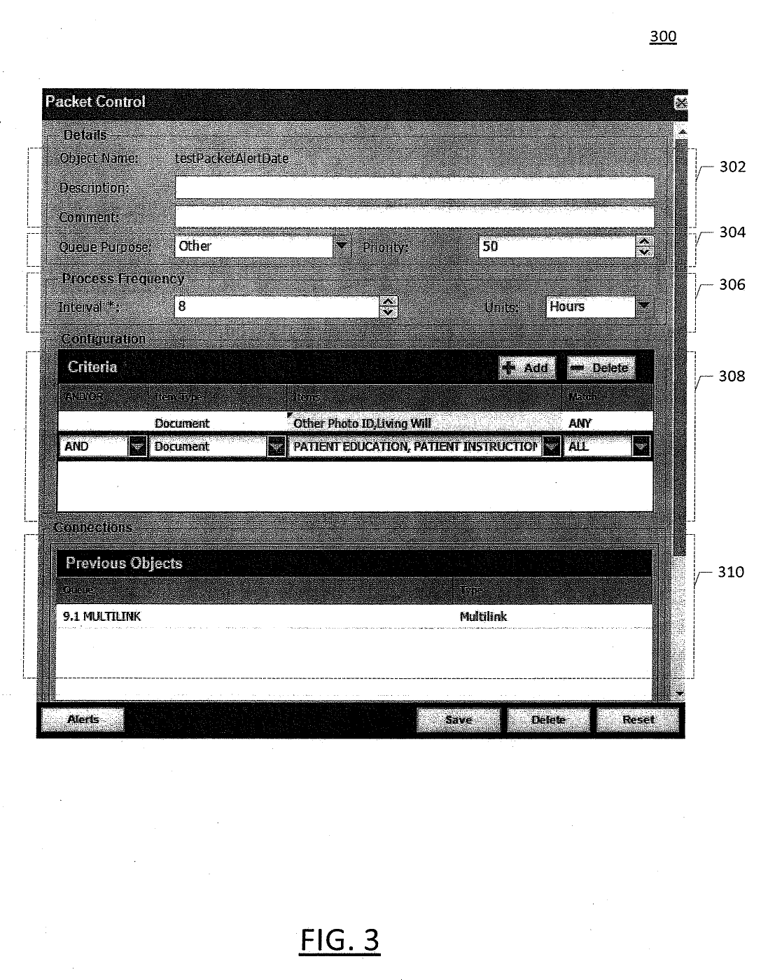

The workflow authoring circuitry 114 includes hardware configured to provide an interface for definition and generation of one or more document workflow objects for use by a workflow engine. An example interface such as may be provided by the workflow authoring circuitry is described further below with respect to FIG. 3. The workflow authoring circuitry 114 may be configured to provide such an interface that allows a user to define particular tasks, criteria, and metadata for association with a document workflow object that is to be used by a document workflow engine. The workflow authoring circuitry 114 may include hardware configured to generate a document workflow object including a single string including a set of rules and/or criteria for evaluation by a document workflow engine. The document workflow object may be transmitted to a document workflow engine, such as provided by the workflow engine circuitry 112. In some embodiments, the workflow authoring circuitry 114 includes hardware, such as the communications circuitry 108, for transmission of the document workflow object to another computing node executing the document workflow engine, while in other embodiments the document workflow object may be stored locally in the memory 104 for use by the document workflow engine. Providing of the interface and generating the document workflow object may be provided by a processor, such as the processor 102, though it should also be appreciated that the workflow authoring circuitry 114 may include a separate processor, FPGA, ASIC, or the like for performing these and other functions. Accordingly, the workflow authoring circuitry 114 is therefore implemented using hardware components of the apparatus configured by either hardware or software for performing the various functions as described herein.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

Embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having now described an apparatus configured to implement and/or support implementation of various embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Exemplary Document Workflow Management Framework Data Flow

FIG. 2 is an illustration of an example of a workflow execution framework 200 in accordance with example embodiments of the present invention. The workflow execution framework 200 flow illustrates communications between and among components of a system for generating document workflow objects, storing those document workflow objects, and using a document workflow engine to evaluate the stored document workflow objects as described herein. The workflow execution framework 200 may include a workflow authoring component 202, a workflow engine 208, and a record datastore 206 in communication with one another.

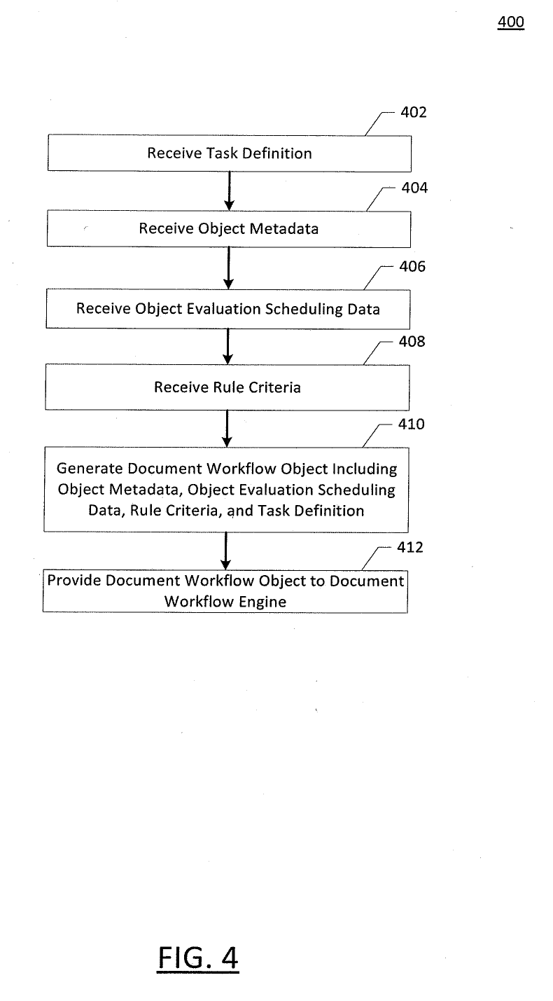

In some embodiments, the workflow authoring component 202 is implemented by workflow authoring circuitry, such as described above with respect to the workflow authoring circuitry 114 of FIG. 1. The workflow authoring component 202 may provide an interface for defining components of a document workflow object 204. The interface may allow a user to input metadata, scheduling data, and rule criteria for the document workflow object 204, and convert the input into a document workflow object having an appropriate structure for evaluation by the workflow engine 208. In some embodiments, the workflow authoring component 202 may communicate with the record datastore 206 to determine metadata about the record datastore 206 and/or documents stored therein. For example, the workflow authoring component 202 may populate a set of drop-down lists or other interface controls with particular document types, document names, document views, or the like for selection by a user when authoring a document workflow object. Upon selection of the appropriate values for the document workflow object and selection of an appropriate interface control (e.g., a “save” or “submit” control), the workflow authoring component 202 may generate the document workflow object 204. It should also be appreciated that the workflow authoring component 202 may also allow for accessing of previously stored document workflow objects, editing of previously stored document workflow objects, deletion of document workflow objects, and the like. An example of an interface that may be provided by a workflow authoring component 202 is described further below with respect to FIG. 3. An example of a process for generating a document workflow object that may be performed by a workflow authoring component is described further below with respect to FIG. 4.

The document workflow object 204 may be generated by the workflow authoring component 202 and provided to the workflow engine 208. The document workflow object may be provided to the workflow engine via a variety of methods, including but not limited to storage of the document workflow object in a datastore (e.g., an object datastore 216 as described further below), transmission of the document workflow object over a network, through the use of an API interface with the workflow engine, and/or the like.

The document workflow object 204 may include a set of metadata 218, scheduling data 220, rule criteria 222, and a task definition 224. The metadata 218 may include a name of the document workflow object, a time and/or date of creation, a comment associated with the document workflow object, a type of the document workflow object, or the like. The scheduling data 220 may include data indicating a frequency and/or priority for use by the workflow engine 208 to control whether and/or when to evaluate the document workflow object. The rule criteria 222 may include one or more criteria for evaluation to determine whether to perform one or more tasks included in the task definition 224. The rule criteria 222 may be implemented in a string data format, for example, and parsed at run-time by the workflow engine 208. The task definition 224 may include electronic data specifying a particular task, processing, application, function, code, or the like to be performed in response to evaluating the rule criteria 222 in a certain manner. For example, if the rule criteria 222 is satisfied, the task definition 224 may indicate that a particular alert should be sent, that a particular process should activate, that a particular document should be sent to the attention of a user, or the like. In some embodiments, workflow objects may be dependent upon one another, such that evaluation of the criteria of a particular document workflow object may also require evaluation of other document workflow objects. In some embodiments, workflow objects may have a circular dependency. This type of setup contains more objects than just document workflow objects in order to implement a complete workflow. Such circular dependencies may be detected by components of the framework and a user may be alerted in response. In some circumstances, such circular dependencies may be desirable or not flagged as errors, such as in the case where a loop is regularly checked for the presence of a particular document, and the loop repeats if the document is not present.

An example of a set of rule criteria as stored in a string format as a component of a document workflow object is provided as follows:

TABLE 1

```
{
“_waitRule”:
    [
      {
    “_ruleRequired”:“”,
    “_ruleType”:“Document”,
    “_itemRule”:“ANY”,
    “_itemListString”:
    [
    “Other Photo ID”,
    “Living Will”
      ],
      “_recordList”:[ ],
  “_documentList”:
  [
  {
  “_documentId”:“Other Photo ID”,
  “_documentName”:“Other Photo ID”,
  “_selected”:true
  },
  {
  “_documentId”:“Living Will”,
  “_documentName”:“Living Will”,
  “_selected”:true
  }
  ]
},
{
  “_ruleRequired”:“AND”,
  “_ruleType”:“Document”,
  “_itemRule”:“ALL”,
  “_itemListString”:
  [
  “PATIENT EDUCATION”,
  “PATIENT INSTRUCTIONS”
  ],
  “_recordList”:[ ],
  “_documentList”:
  [
  {
  “_documentId”:“PATIENT EDUCATION”,
  “_documentName”:“PATIENT EDUCATION”,
  “_selected”:true
  },
  {
  “_documentId”:“PATIENT INSTRUCTIONS”,
  “_documentName”:“PATIENT INSTRUCTIONS”,
  “_selected”:true
  }
  ]
}
]
}
```

An example interface for defining the rule criteria as indicated in Table 1 above is described further below with respect to FIG. 3.

The document workflow object 204 is provided to the workflow engine 208 and stored within an object datastore 216. The object datastore 216 may be implemented as, for example, a table with rows of the table storing individual document workflow objects. Columns of the table may indicate an identifier for each document workflow object, a timestamp for next evaluation of the document workflow object, a frequency for evaluation of the document workflow object, an identifier for one or more tasks to be performed based on a set of rule criteria, and the set of rule criteria. In particular, embodiments may store the set of rule criteria as a single string. The string may, for example, define a JSON object. At run-time, the string may be parsed and used to generate a JSON object that is used by the rule engine to evaluate the rule criteria.

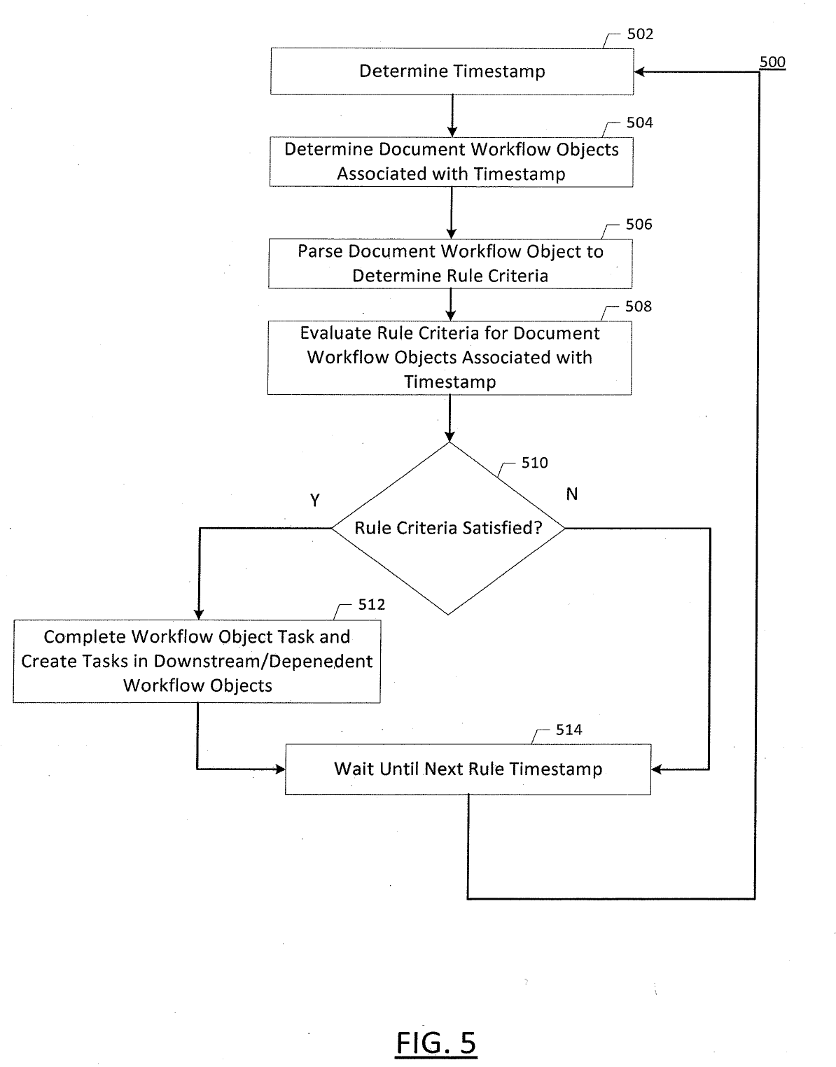

The workflow engine 208 may include a scheduler 210, a rule evaluation component 212, a task execution component 214, and the object datastore 216. An example process for evaluating a document workflow object that may be performed by the workflow engine 208 is described further below with respect to FIG. 5.

The task scheduler 210 may determine a present timestamp and execution times for one or more of the document workflow objects stored in the object datastore 216. The task scheduler 210 may use the scheduling data 220 associated with each document workflow object to perform these tasks. In this manner, administrators of the framework and/or authors of the document workflow object 204 may control whether and when particular document workflow objects are evaluated. For example, some execution environments (e.g., large hospitals) may have hundreds, thousands, or even hundreds of thousands of workflow objects to be evaluated on a given day. At the time the workflow object is defined, the user may select a particular interval for evaluation based on the time-sensitivity of the document workflow object. In this manner, tasks that are likely to require evaluation multiple times in a given day (e.g., detecting high priority documents, such as urgent lab results) may have a higher priority, while tasks that are not likely to change frequently (e.g., updating patient insurance billing information) may be performed less frequently (e.g., once/day). Management of the frequency with which associated document workflow objects are evaluated may allow authors of document workflow objects and system administrators to advantageously manage system processing resources. Embodiments of the scheduler 210 may also utilize priority information associated with the document workflow object scheduling data 220 to prioritize certain tasks over others, such that, given limited resources, tasks with a higher priority are executed before or to the exclusion of tasks with a lower priority.

The scheduler 210 may identify particular document workflow objects for evaluation based on scheduling information 220 as described above. When a particular document workflow object is identified for evaluation, the scheduler 210 may notify a rule evaluation component to evaluate whether the rule criteria associated with the document workflow object has been satisfied. This process includes parsing the rule criteria (e.g., parsing a string) for the document workflow object and determining whether the rule criteria are satisfied by records stored within the record datastore 206. The rule evaluation component 212 may transform a string representation of the rule criteria into another format, such as by converting the string into a machine-readable format for evaluating the rule criteria. For example, a JSON conversion library, such as GSON by Google® may be used to manipulate document workflow objects to and from JSON. During the actual evaluation, executable code, such as JAVA® models may be used during the actual evaluation. These models may be created from the JSON model representing the current object being evaluated. The rule evaluation component 212 determines whether the rule criteria have been satisfied for performing at least one task associated with the document workflow object. If the rule criteria for a task have been met, the rule evaluation component notifies the task execution component 214 of the particular task to be executed.

Each document workflow object may contain the metadata, scheduling data, and rule criteria that make up that instance of the object. This information collectively may be defined as a “queue” for a particular task or tasks. Each document workflow object instance may therefore act as a holder/container/queue for tasks of that type. When a task is created, the task may be assigned to a particular “queue” as described above. All tasks may be included within a single table that uniquely identifies each task and within which queue the task exists. When the task is identified for processing (e.g., at the interval specified by the scheduling information) the processor may use the task identifier specified within the table to lookup how each queue is defined and react accordingly.

When the rule criteria are met for a given packet control, the workflow engine may create any and all downstream tasks from said packet control. Each of these tasks may, in turn, be defined by the “queues” that exist within the task. One example of another queue is a “Hold” queue which can be configured to just wait for a certain period of time (e.g., a number of days) before starting additional work. Another example would be a “Follow up” queue which is configured so that signatures can be collected from authors or authenticators of the documents that are held within the record datastore 206. Document workflow objects may be linked to normal group queues to which one or many analysts or coders (e.g., users who are responsible for applying diagnostic or procedure codes to documents) have access. For example, the analysts may review the documents for missing signatures while the coders make sure any and all diagnosis and procedure codes within the patient's charts are correct to ensure insurance processing goes smoothly and a hospital gets reimbursed for its services. An output queue may also be available to the hospitals where they can configure the documents to be output to printers, fax machines, e-mail addresses, or to disk.

The task execution component 214 then executes the task associated with the criteria identified as met by the rule evaluation component 212. For example, as noted above, the task execution component 214 may take certain actions with respect to accessing documents, modifying documents, sending alerts and notifications, or the like in response to receiving a notification that a given set of rule criteria have been met for a particular task.

### Exemplary Interface for Generating a Document Workflow Object

FIG. 3 is an illustration of an example of an interface 300 for providing information for generating a document workflow object in accordance with embodiments of the present invention. The interface 300 includes various data entry fields for providing object description data 302, object execution data 304, object scheduling data 306, and object rule criteria 308. The interface also includes a dependency visualization interface control 310 for visualizing dependencies and associations with other document workflow objects.

The object description data 302 that may be entered via the interface 300 includes a data entry field for an object name, an object description, and an object comment. The object name field may be a unique identifier defined a single time when the object is first generated, such that the object name field is used to index the document workflow object. Accordingly, this field may be immutable or otherwise uneditable at a later time. The object description data 302 fields may also include a field for entry of a text description of the document workflow object, and a text comment related to the document workflow object. Data entered in the object description data 302 fields may be stored with the document workflow object, though it should be appreciated that various other metadata may also be associated with the document workflow object and also stored (e.g., date/time of creation, date/time of last edit, associated task type, author of the document workflow object, etc.). The object execution data 304 includes fields for the user to specify a particular type of workflow object for auditing, tracking, and/or performance monitoring purposes, and a priority for the document workflow object. As noted above, the priority may be employed to selectively evaluate certain document workflow objects ahead of others.

The object scheduling data 304 includes data entry fields allowing a user to specify a frequency interval for evaluating the document workflow object. For example, the present interface 300 depicts a selected evaluation interval of 8 hours, such that the generated document workflow object will be evaluated every 8 hours.

The object rule criteria 308 allows specification of various rules that, when evaluated as true, cause the document workflow object to perform a certain task. Individual criteria may relate to the presence of certain records within a document repository, the presence of groups of documents in the document repository, the presence of at least one of a group of documents in the document repository, and various logical and/or Boolean operations performed on multiple criteria. For example, the document workflow object defined within the interface 300 includes a first criterion that requires the presence of any one of an “Other Photo ID” or a “Living Will” and also the presence of a “patient education” and “patient instruction” document. If the document repository meets these criteria, then the document workflow object criteria are satisfied and thus the task or tasks associated with the document workflow object will be performed. Although the instant example relates to individual document types, it should also be appreciated that criteria may be associated with groups of documents (e.g., a particular document “record view” of a document repository), or other document workflow objects. In the present context, the term “view” refers to a particular filter applied to a set of documents stored in a document repository. The “record view” is understood to be satisfied or “true” if at least one of each document associated with the view is present in the document repository. During processing of a workflow engine, a current context of the records repository may be used to determine if the correct document types are present within the system. For instance, given a patient encounter, a determination is made whether the particular required document types exist for that patient encounter.

The interface 300 may provide a variety of controls, windows, and help objects for assisting the author with selecting or entering rule criteria. For example, document type fields may be automatically populated with a set of document types stored in a document repository, rule templates from other document workflow objects may be selected as a starting point, and the like. It should be appreciated that the interface 300 may communicate with a workflow engine and/or document repository to receive such data to improve the user experience for authoring of document workflow objects.

As noted above, document workflow objects may depend upon one another. The dependency visualization interface control 310 depicts other document workflow objects that include the instant document workflow object within their own criteria. As described in the interface 300, the present document workflow object is used as a criterion of the “9.1 MULTILINK” object, which is of type “multilink”.

Upon selection of a “save” or “submit” interface control, the interface 300 may cause a workflow authoring component to generate a document workflow object as described above with respect to FIGS. 1-2. This process includes generation of a string including the rule criteria, along with packaging the string with various other document workflow object components such as described above with respect to FIG. 2. An example of a rule string for the criteria displayed in the exemplary interface 300 would be the exemplary rule string provided above with respect to Table 1.

### Exemplary Processes for Implementing a Document Management Workflow

FIG. 4 is a flow diagram illustrating an example of a process 400 for generating a document workflow object in accordance with example embodiments of the present invention. The process 400 is operable to receive a set of parameters or attributes for a document workflow object, and to generate a document workflow object that may be utilized by a workflow engine for evaluating documents held in a document repository as described above. The process 300 advantageously provides a straightforward, flexible, robust mechanism for definition of document workflow objects. The process 400 may be performed, for example, by an apparatus such as the apparatus 100 described above with respect to FIG. 1, through the use of a workflow authoring component 202 as described above with respect to FIG. 2, and/or through the use of an interface 300 as described above with respect to FIG. 3.

At action 402, task definition data is received. The task definition data may be an indication of which task is to be performed in response to satisfaction of the document workflow object. In some embodiments, the task definition data may merely be a return value (e.g., “return true” or “return false”), if another document workflow object depends upon the document workflow object being authored. It should be appreciated that a variety of tasks may be defined for the document workflow object, including but not limited to various tasks coded into the system by default (e.g., by specifying a task identifier), arbitrary code (e.g., by including executable code within the document workflow object), or the like. As noted above, tasks may be provided to a particular queue as defined by a document workflow object, such that the document workflow object functions as a container for the task being evaluated. Upon the criteria for the document workflow object being met, the particular task assigned to the document workflow object (e.g., the type of the document workflow object) is executed by performing an evaluation of the criteria and taking the appropriate action if the criteria are met.

At action 404, object metadata for the document workflow object is received. As noted above, the object metadata may include data related to annotating or commenting the document workflow object (e.g., a descriptive name, comment, or the like), or data used for monitoring and auditing purposes (e.g., a type). At action 406, object evaluation scheduling data is received. The object evaluation scheduling data may define how frequently the document workflow object is to be evaluated by a workflow engine, the priority of the document workflow object for evaluation, or the like. At action 408, a set of rule criteria may be defined. As noted above, the set of rule criteria may include a variety of conditions, document types, view types, and the like that, when evaluated by a workflow engine, assist with evaluating the document workflow object. Generally, when the rule criteria is evaluated as true by the workflow engine, the workflow engine may cause a task associated with the document workflow object to be performed.

At action 410, the document workflow object is generated using the data received at actions 402, 404, 406, and 408. As noted above, generation of the document workflow object may include generation of a string that defines a JSON structure containing the rule criteria. The other sets of received data may also be included in the string in some embodiments, while in other embodiments the other sets of data may be stored in other data structures associated with the document workflow object.

At action 412, the document workflow object is provided to a workflow engine. As noted above, providing the document workflow object may include storing the document workflow object in a table, transmitting one or more network data packets including the document workflow object to another computing node, or the like.

FIG. 5 is a flow diagram illustrating an example of a process 500 for evaluating one or more document workflow objects and managing a document workflow using said document workflow objects in accordance with example embodiments of the present invention. The process 500 is operable to schedule the evaluation of document workflow objects, evaluate the document workflow objects at the scheduled time based on documents stored in a document repository, and perform certain tasks in response to evaluating the document workflow objects. Embodiments may function by parsing rule criteria stored in a string or JSON format as part of the document workflow objects, and using the parsed rule criteria to determine whether or not to perform a task associated with the document workflow object. The process 500 may be performed, for example, by an apparatus such as the apparatus 100 described above with respect to FIG. 1, and/or through the use of a workflow engine 208 as described above with respect to FIG. 2.

At action 502, a current timestamp is determined. The timestamp may be determined using an internal system clock, an external time reference, a time reference internal to the workflow engine or any other various mechanisms for determining a current time for the workflow engine. At action 504, the process 500 determines whether any document workflow objects are associated with the current timestamp. In some embodiments, the process 500 may update a timestamp associated with each document workflow object upon evaluation of that document workflow object. For example, when a given document workflow object is evaluated, the process 500 may update a data field associated with that document workflow object (e.g., a column in a table storing the document workflow object) by adding a frequency interval for that document workflow object to the current time. Alternatively, the process 500 may store a time of last execution for each document workflow object, and then compare the current time to the time of last execution for each document workflow object to determine if longer than a defined frequency associated with that document workflow object has elapsed. Regardless of the mechanism used to select document workflow objects for analysis, once the process 500 has determined that it is time to evaluate a particular document workflow object, the process proceeds to action 506.

At action 506, a set of rule criteria associated with the document workflow object are parsed. As noted above, the rule criteria may be stored as a set of string data to allow for flexible definition of a set of criteria without being confined to a particular schema or structure. In some embodiments, the set of rule criteria is a JSON structure. Parsing of the set of rule criteria may result in a machine-readable set of instructions that may be used by a workflow engine to evaluate the document workflow object. For example, if the rule criteria specify that a particular document or document type should be present, the workflow engine may execute processing to query a document repository to determine whether the document or document type is present in the repository.

At action 508, the rule criteria are evaluated. As noted above, evaluation of the rule criteria may include performing one or more queries against a records datastore to determine if the requirements of the rule criteria are satisfied (e.g., whether particular documents are present, whether document views are satisfied, etc.). At action 510, if the rule criteria are satisfied, the process 500 proceeds to action 512 and tasks associated with the document workflow object are completed and any tasks associated with downstream or dependent workflow objects are created. After executing the task or if the rule criteria are not satisfied, the process proceeds to action 514 where the process waits until the next appropriate timestamp. In some embodiments, after evaluating the selected document workflow object, an entry is made as to the last time of evaluation of that document workflow object, or a timer is started such that, upon expiration, the document workflow object is evaluated again. After waiting for the next timestamp, the process returns to action 502 to identify more document workflow objects for evaluation.

Accordingly, embodiments provide for a flexible, robust framework that allows for user-defined document workflow objects. Such document workflow objects advantageously allow for the user to configure different sets of rule criteria without the need to generate custom code for each set of criteria. Embodiments also provide for novel interfaces that simplify the process of creating document workflow objects.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for managing a document workflow, comprising:
receiving a document workflow object, the document workflow object comprising a string defining a set of rule criteria and an indicator of at least one task to be performed in response to meeting the set of rule criteria;
storing the document workflow object in an object datastore, the object datastore stored in a memory;
evaluating the document workflow object using a workflow engine executed on a processor, wherein evaluating the document workflow object comprises:
parsing the string to generate a set of machine-readable instructions for evaluating the rule criteria;
executing the instructions to evaluate the rule criteria; and
determining that the rule criteria are satisfied based at least in part on execution of the instructions determining that at least one document is present within a document repository; and
in response to evaluating the document workflow object, executing, by the workflow engine, the at least one task.

2. The method of claim 1, wherein the document repository is a medical records document store.

3. The method of claim 1, wherein the document workflow object further comprises a frequency interval, and wherein the document workflow object is evaluated by the workflow engine at a particular time based at least in part on the frequency interval.

4. The method of claim 1, wherein the string defines a JavaScript Object Notation (JSON) object.

5. The method of claim 1, wherein the document workflow object is received from an interface configured to generate the document workflow object based on user input received by the interface.

6. The method of claim 1, wherein the machine-readable instructions determined from parsing the rule criteria comprise at least one query executed against the document repository.

7. The method of claim 1, wherein the rule criteria defines at least one document view, the document view comprising a plurality of document types stored in the document repository.

8. The method of claim 1, wherein the document workflow object further comprises a first priority rating for evaluation of the document workflow object, and wherein the document workflow object is selected for evaluation based at least in part on the first priority rating being greater than at least one other priority rating associated with a different document workflow object.

9. The method of claim 1, further comprising determining that the rule criteria have not been met based on execution of the machine-readable instructions and, in response to determining that the rule criteria have not been met, scheduling a subsequent evaluation of the document workflow object by the workflow engine.

10. The method of claim 9, wherein a time of the subsequent evaluation is determined based at least in part on a frequency interval associated with the document workflow object.

11. An apparatus for managing a document workflow, the apparatus comprising workflow engine circuitry configured to:
receive a document workflow object, the document workflow object comprising a string defining a set of rule criteria and an indicator of at least one task to be performed in response to meeting the set of rule criteria;
store the document workflow object in an object datastore, the object datastore stored in a memory;
evaluate the document workflow object using a workflow engine executed on a processor, wherein evaluating the document workflow object comprises:
parsing the string to generate a set of machine-readable instructions for evaluating the rule criteria;
executing the instructions to evaluate the rule criteria; and
determining that the rule criteria are satisfied based at least in part on execution of the instructions determining that at least one document is present within a document repository; and
in response to evaluating the document workflow object, execute the at least one task.

12. The apparatus of claim 11, wherein the document repository is a medical records document store.

13. The apparatus of claim 11, wherein the document workflow object further comprises a frequency interval, and wherein the document workflow object is evaluated by the workflow engine at a particular time based at least in part on the frequency interval.

14. The apparatus of claim 11, wherein the string defines a JavaScript Object Notation (JSON) object.

15. The apparatus of claim 11, wherein the document workflow object further comprises a first priority rating for evaluation of the document workflow object, and wherein the document workflow object is selected for evaluation based at least in part on the first priority rating being greater than at least one other priority rating associated with a different document workflow object.

16. The apparatus of claim 11, wherein the workflow engine circuitry is further configured to determine that the rule criteria have not been met based on execution of the machine-readable instructions and, in response to determining that the rule criteria have not been met, schedule a subsequent evaluation of the document workflow object by the workflow engine.

17. The apparatus of claim 16, wherein a time of the subsequent evaluation is determined based at least in part on a frequency interval associated with the document workflow object.

18. A non-transitory computer readable storage medium comprising instructions that, when executed by a processor, configure the processor to:
receive a document workflow object, the document workflow object comprising a string defining a set of rule criteria and an indicator of at least one task to be performed in response to meeting the set of rule criteria;
store the document workflow object in an object datastore, the object datastore stored in a memory;
evaluate the document workflow object using a workflow engine executed on a processor, wherein evaluating the document workflow object comprises:
parsing the string to generate a set of machine-readable instructions for evaluating the rule criteria;
executing the instructions to evaluate the rule criteria; and
determining that the rule criteria are satisfied based at least in part on execution of the instructions determining that at least one document is present within a document repository; and
in response to evaluating the document workflow object, execute the at least one task.

19. The computer readable storage medium of claim 18, wherein the document repository is a medical records document store.

20. The computer readable storage medium of claim 18, wherein the document workflow object further comprises a frequency interval, and wherein the document workflow object is evaluated by the workflow engine at a particular time based at least in part on the frequency interval.
